(19) United States
(12) Patent Application Publication
(10) Pub. No.: US 2006/0013926 A1
(43) Pub. Date: Jan. 19, 2006

(54) Magnetic dispensing funnel

(76) Inventors: H. McMillan Lindsey, Westminster, CA (US); Thomas A. Thompson, Long Beach, CA (US); Patrick L. Farrell, Huntington Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 10/892,927

(22) Filed: Jul. 16, 2004

(51) Int. Cl. A21D 6/00

(52) U.S. Cl. 426/237

(57) ABSTRACT

A device for improving organoleptic properties for various beverages includes a base and a tubular member extending longitudinally through the base. A spout extends outwardly from the tubular member and at least two magnets disposed longitudinally along the tubular member are provided for exposing the beverage to a magnetic field as the beverage passes through the tubular member and spout. A funnel member extending outwardly from the base and is in fluid communication with the tubular member and a support member is provided for centering the funnel under a dispensing spout.

The present invention generally relates to apparatus and methods for improving the organolaptic properties of alcoholic beverages and is more particularly directed to apparatus and method for exposing bottled beverages to a magnetic field. With respect to alcoholic beverages, the present invention reduces the perception of tannins and acid. Such alcoholic beverages include wine, brandies, sherries, ports, cognac, spirits, beer, and any other alcoholic beverage.

Besides the tannins in wine, there are polyphenolic compounds in coffee, tea, fruit juice, and vegetable juice. The production processes of these beverages in such that the polyphenolic compounds found in coffee beans, tea leaves, fruit skins and seeds, and vegetable skins and seeds are extracted into the beverages, either by the action of heat, enzymes, mechanical action, or combination thereof. These compounds have become increasingly investigated and are integral to the health promoting properties of some of these beverages. As such, there is a trend to increase such polyphenolic compounds in such beverages. The downside of such extraction is that bitterness is a side effect of such polyphenols and the processing process. These tannins and polyphenols also tend to obscure the underlying flavors of the coffee, tea, wine, spirits, beer, fruit juice, and vegetable juice.

As is well known, tannins are harsh, bitter, astringent, and dry tasting compounds in wines which are caused by grape skins, seeds, stems, or the use of wood, such as in barrels, strips of chips, which often are utilized for the aging of wine or to impart desired taste characteristics to alcoholic beverages, including wines, fortified wines, and whiskeys.

As is also well known in wines, such tannins polymerize during aging and accordingly older wines generally have a softer texture, smoother, and fruiter taste than the same wine at a younger age.

The use of magnets to alter the composition of tannins in alcoholic beverages, particularly wine, has been known for some time. For example, as early as 1900, magnetic drinking cups were developed, see U.S. Pat. No. 855,413. U.S. Pat. No. 4,872,401 provides for a device for improving the flavor or removing the piquant flavor of fermented products utilizing a container with surrounding walls having magnets disposed thereon. In this manner, the composition of the tannins is altered so as to make the perception of astringency less.

U.S. Pat. No. 5,556,654 provides for passing a liquid through a magnetic field in order to enhance the flavor of the liquid utilizing tubular permanent magnets for treating a liquid prior to bottling thereof.

U.S. Pat. No. 5,860,353 provides for apparatus and a method for accelerating aging of alcoholic liquids such as wines, brandies, spirits, and the like within bottles disposed in a rack.

U.S. Pat. No. 6,287,614 utilizes a coaster having a magnet for improving the organoleptic properties of alcohol in a bottle.

U.S. Pat. No. 6,390,319 provides for a beverage container having a volume exposed to magnetic fields.

U.S. patent application 2003/0003189 A1 provides for establishing a magnetic field within a bottle in order to cause certain molecules in the wine to flow from the bottom of the bottle to the top in a constant motion along the flux lines of the magnetic field between the bottom and the top of the magnet.

U.S. patent application 2003/0028070 A1 provides for a method for restructuring an ingestible substance and constituents thereof by providing magnetic fields of specific flux densities.

U.S. patent application Ser. No. 2003/0226447 A1 provides for a beverage flavor enhancing device having a base and a plurality of tubular members extending upwardly from the base and arrange in a spaced apart relationship to receive the beverage container and subject any container to a magnetic field.

It is clear that none of the hereinabove developed devices provide a convenient means for an end user, such as a wine connoisseur, to conveniently and selectively magnetically treat wine or other alcoholic beverage without extensive apparatus or without treating an entire bottle of alcoholic beverage. It should be clear that if an entire bottle is treated with a magnetic field to effect the organoleptic qualities of the beverage contained therein there can be no real specific comparison of treated and untreated beverage from the same bottle.

The present invention provides for a funnel for enabling selective magnetic treatment of alcoholic beverages which is convenient, simple to use, and does not require extensive equipment or the bulk treatment of alcoholic beverage.

### SUMMARY OF THE INVENTION

A magnetic dispersion device in accordance with the present invention includes a funnel member extending outwardly from a base and in fluid communication with a tubular member. More particularly, the device may include a support member extending from the funnel for placement under a storage container, such as a box, to orient the funnel under a spout extending from the beverage container.

It follows that a method in accordance with the present invention utilizing device the present invention includes disposing the support member of the funnel under the alcoholic beverage container, centering the funnel under an outlet spout of the beverage container and thereafter decanting the beverage from the container, or box, and through the funnel and tubular member to expose the beverage to the magnetic field as the beverage is decanted from the box or container.

### BRIEF DESCRIPTION OF THE DRAWINGS

The advantages and features of the present invention will be better understood by the following description when considered in conjunction with the accompanying drawings in which:

FIG. 1 is a side view of the device in accordance with the present invention as it may be disposed in conjunction with a beverage container, or box, for orienting a funnel portion thereof beneath a spout; and

FIG. 2 is a cross sectional view of the device illustrating exposure of a beverage to a magnetic field.

### DETAILED DESCRIPTION

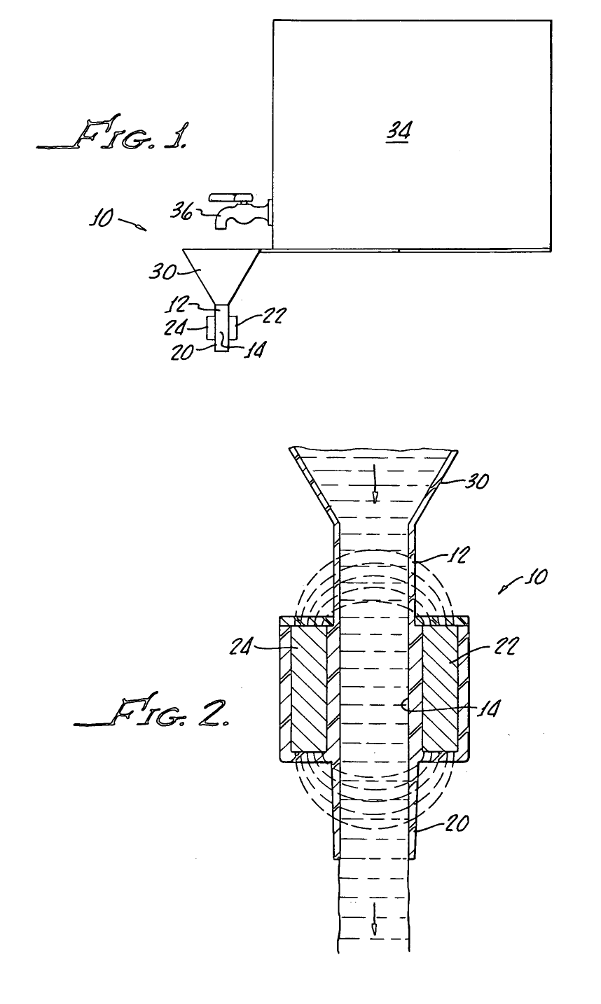

With reference now to FIGS. 1 and 2, a magnetic dispensing device 10 in accordance with the present invention includes a base 12, a tubular member 14 extending outwardly from the base 12 and a spout 20 extending outwardly from the tubular member 14.

At least two permanent magnets 22, 24 are disposed longitudinally along the tubular member 14 in order to expose the beverage to a magnetic field as the beverage passes through the tubular member 14 and spout 20.

More particularly, the device 10 includes a funnel 30 extending outwardly from the base 12 and in fluid communication with the tubular member 14.

As shown in use with a wine or beverage box 34 having a spout 36, the device 10 includes a support member 40 for placement under the beverage container 34 in order to orient the funnel 30 under the spout 36 extending from the beverage container 34.

As is the case with the device 10 may be molded from a single piece of suitable plastic with the magnets 22, 24 embedded therein.

It follows that a method utilizing the device 10, includes disposing the support member 40 under the container 34 and centering the funnel 30 under the spout 36. Thereafter, the beverage is released from the box and passes through the funnel 30 and tubular member 14 and spout 20 to expose the beverage to the magnetic field developed by the magnets 22, 24 as the beverage is decanted from the box.

The funnel device 10 includes with a relatively small aperture in the tubular member 14 (to ensure a strong magnetic field), flanked by two strong magnets 22, 24. The fluid, as it passes the strong magnetic field, causes an alteration in the configuration of the charged particles that impart bitterness in these beverages. With immediate exposure to air, chemical changes occur to the structure and configuration of these polyphenols and other chemical so as to make the beverages taste less bitter and less astringent. Underlying flavors inherent to the beverage become unmasked and the beverage is perceived to taste more flavorful and smoother. In the case of tannic red wines, the perception is that of fruitier and softer. In the case of coffee or tea, the perception is one of enhanced flavor, increased richness, decreased bitterness and decreased astringency. As per the wine experiments, this effect has been observed in a blind tasting fashion by the inventors and others. Repeatedly, most tasters prefer the sample treated with the magnetic pourer. As per the wine experiments, this effect requires the strong magnetic field and immediate exposure to oxygen. Without oxygen, the softening effect upon the beverage is diminished.

The funnel device 10 allows a single device 10 to be used for a variety of beverages and fluids. Rather than affixing the device to a vessel containing a beverage, the funnel device 10 allows the bottle, carton, pot, or spigot to dispense beverage directly into the funnel 30. The fluid 30 is funneled into a stem or tubular member 14 which has magnets 22, 24 placed on either side so as to produce a strong magnetic field. The efficacy of this funnel has been tested with a host of beverages including red wine, oaked white wine, coffee, tea, fruit juice, vegetable juice, spirits, and dark beer. The effect of the magnetized funnel device 10 is consistent. The beverages exposed to a strong magnetic field as it passes through the funnel and its stem, and then to oxygen undergoes chemical changes so as to make the beverages softer, richer, less bitter, and less astringent.

### EXAMPLE 1

With regard to red wine and some oak matured white wines, the magnetic wine pourer consistently renders wine in the glass fruitier, softer, and less astringent. This has been found consistently for a variety of red wines, most of recent vintages, and have includes wines from: California, Bordeaux, Rhone Valley, Piedmont, Tuscany, Spain, Washington State, Chile, Argentina, South Africa, and Australia. Varieties tested include: cabernet sauvignon, cabernet, franc, merlot, syrah, grenache, Rhone blends, Bordeaux blends, pinot noir, zinfandel, sangiovese, barbera, nebbiolo, tempranillo, and malbec.

As expected for any taste preference, individuals vary with regard to their preferences. Some consistently prefer the magnetized wine, others consistently prefer non-magnetized wine, while a third group tended to prefer a blend of the two. Most preferred the magnetized wine for some examples, and non-magnetized wines for other samples poured. A generalization that can be made from the tasting experiments was that wines that were overly astringent to begin with, either from harsh tannins, excessive extraction of tannins, or being opened without sufficient bottle age, benefited the most from being poured through the magnetic pourer.

Besides making red wines taste fruitier and softer, the magnetic pourer also made some red wines taste less vegetal, less herbaceous. A characteristic of less than ripe cabernet sauvignon (also cabernet franc, merlot, malbec, and syrah) is that of vegetal, herbaceous characteristics, including bell pepper, green peppercorns, quince, weediness. Winemakers go to great efforts in vineyard site selection, vineyard work, and winemaking techniques (such as micro-oxidation) to decrease these characters. The magnetic wine pourer had a dramatic impact upon such wines, markedly decreasing the vegetal/herbaceous/weedy character of the wine, and thus significantly improving the taste profile. This was particularly true of Chilean wines and mass-produced red wines from California and France.

Proposed mechanisms, which include the polymerization and structural changes of tannins and anthocyanins in the wine, which can lead to decreased astringency and softer, fruitier wines have been discussed in the cited patents.

### EXAMPLE 2

Oxygen, via the process of decanting, or during oxidation production racking or micro-oxidation, greatly encourages softening of wines via such chemical changes involving tannins. As such, it is theorized that oxygen was playing a role with regard to device in accordance with the present invention. An experiment was conducted whereby wine was poured, with the magnetic pourer in place, in an oxygen-free environment. The same wine was poured in the presence of oxygen both with and without the magnetic pourer. A recent vintage Chilean cabernet sauvignon was the wine poured. The non-magnetized wine was harshly astringent from hard tannins. The magnetic poured, in the absence of oxygen, did soften the wine slightly. There was a marked difference when the wine was poured through the magnetic pourer in the presence of oxygen. The wine was then made much less herbaceous, and much less astringent while having markedly improved fruit profile. This demonstrates that the combination of oxygen and the magnetic field work in concert to alter the chemistry of the wine to allow for a rapid softening and improvement of the fruit profile.

The pourer 10 is also effects on white wines. The magnetic pourer reproducibly makes over-oaked wines, such as oaky chardonnay, far more approachable, less tannic, and fruiter. The same effect would be expected on other, heavily oaked white wines.

Although there has been hereinabove described a specific magnet dispensing device in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A device for improving organoleptic properties of various beverages, the pourer comprising:
a base;
a tubular member extending longitudinally through said base;
a spout extending outwardly from said tubular member;
at least two magnets disposed longitudinally along said tubular member for exposing beverage to a magnetic field as the beverage passes through said tubular member and spout; and
a funnel member extending outwardly from said base and in fluid communication with said tubular member.

2. The decanter according to claim 1 further comprising a support member extending from said device for placement under a beverage container to orient said funnel under a spout extending from said beverage container.

3. The decanter according to claim 2 further comprising magnet support integrally molded with said base tubular member, spout, and funnel member.

4. A method for improving organoleptic properties of boxed beverages, the pourer comprising:
providing a device as claimed in claim 1;
disposing the support member of the device under the beverage box;
centering the funnel under an outlet spout of a beverage box;
releasing the beverage from the box, said beverage passing funnel and tubular member to expose the beverage to a magnet field as the beverage is released from the box.
